(19) United States
(12) Patent Application Publication
(10) Pub. No.: US 2008/0320340 A1
(43) Pub. Date: Dec. 25, 2008

(54) Method and Device for Performing Switchover Operations and for Comparing Data in a Computer System Having at Least Three Execution Units

(76) Inventors: Reinhard Weiberle, Vaihingen/Enz (DE); Bernd Mueller, Gerlingen (DE); Eberhard Boehl, Reutlingen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 11/666,185

(22) PCT Filed: Oct. 25, 2005
(86) PCT No.: PCT/EP2005/055512

§ 371 Date: Apr. 3, 2008

(30) Foreign Application Priority Data
Oct. 25, 2004 (DE) 10 2004 051 937.4
Oct. 25, 2004 (DE) 10 2004 051 950.1
Oct. 25, 2004 (DE) 10 2004 051 952.8
Oct. 25, 2004 (DE) 10 2004 051 964.1
Oct. 25, 2004 (DE) 10 2004 051 992.7
Aug. 8, 2005 (DE) 10 2005 037 240.6

(51) Int. Cl. G06F 9/318; G06F 11/00

(52) U.S. Cl. 714/48; 712/229; 712/E09.035; 714/E11.002

(57) ABSTRACT

A method and a device for performing switchover operations and for comparing data in a computer system having at least three processing units are provided, in which switchover unit is provided, a switchover operations being carried out between at least two operating modes, and a comparison unit is provided. A first operating mode corresponding to a comparison mode, and a second operating mode corresponding to a performance mode are provided. Provision is made in the comparison mode for a voting, at least as a two-out-of-three weighting, and a control unit is provided which may be used to set the voting.

### BACKGROUND OF THE INVENTION

1. Field of the Invention

The present invention relates to a method and a device for performing switchover operations and for comparing data in a computer system having at least three processing units.

2. Description of Related Art

A method for detecting errors in a comparison mode is described in published PCT application document WO 01/46806. In the process, the data are processed and compared in parallel in a processing unit having two ALU processing units. In the event of an error (soft error, transient error), it provides for both ALUs to work independently of one another until the faulty data are removed and a new (partially repeated) redundant processing can be undertaken again. This requires that both ALUs be able to operate synchronously in relation to each other and that the results be able to be compared in a process that maintains clock accuracy.

Methods are known from the related art which provide for switching between a comparison mode used for detecting errors, in which tasks are executed redundantly, and a performance mode used for achieving a higher level of performance. This requires that the processing units be mutually synchronized for the comparison mode. To that end, it is necessary that both processing units be able to be stopped and that they operate synchronously in a process that maintains clock accuracy, to enable the result data to be compared with one another as they are written into the memory. This requires that interventions be made into the hardware; to this end various approaches are proposed.

On the other hand, European Patent EP 0969373 provides that a comparison of the results of redundantly operating processing units be ensured even when they are operating asynchronously in relation to one another, i.e., not in a process that maintains clock accuracy, or with an unknown clock pulse offset.

From the aircraft industry, voting systems are known, which are able to use inputs of standard computers and, by employing a majority decision, to reliably process the same, and thus trigger actions which are critical to safety. One system that combines inter-processing unit and inter-control unit communication is the FME system in which, because of a high degree of redundancy, the system remains operational even in the case of individual or even a plurality of errors, and which was developed by DASA for aerospace (Urban, et al.: A survivable avionics system for space applications, Int. Symposium on Fault-tolerant Computing, FTCS-28 (1998), pp. 372-381). This system can even tolerate Byzantine errors (i.e., particularly virulent errors, where not all components receive the same information, but rather various erroneous information is even “deliberately” distributed by a schemer to different components). Due to the considerable outlay required, such a system is commercially feasible for especially critical systems which are manufactured in very small numbers. A cost-effective approach that can be manufactured in large numbers and, in addition, also offers switchover options, is not known.

### BRIEF SUMMARY OF THE INVENTION

It is, therefore, an object of the present invention to devise a switchover and comparison unit which will make it possible to switch the operating mode of two or more processing units and which, in the process, is able to do so without intervening in the structure of these processing units and also does not require any additional signals for this purpose. In this context, it is intended that various digital or analog signals from various processing units be able to be compared to one another in a comparison mode. Under certain circumstances, the intention is that this comparison even be possible when the processing units are operated using different clock signals and not synchronously in relation to one another. An object of the present invention is, in particular, to provide means and methods which will make a generalized voting possible, using more than two execution units.

A method for performing switchover operations and for comparing data in a computer system having at least three processing units is advantageously provided in accordance with the present invention, switchover means being provided, and switchover operations being carried out between at least two operating modes, comparison means being provided, and a first operating mode corresponding to a comparison mode, and a second operating mode corresponding to a performance mode, characterized in that provision is made in the comparison mode for a voting scheme, at least as a two-out-of-three weighting, control means being provided which may be used to set the voting.

A method is advantageously employed in which the control means at least include storage means or are designed as such, and an identifier for setting the voting, in particular a bit, is stored in the storage means.

A method is advantageously employed in which, as a result of the voting process, an error detection and an error localization are performed, and corresponding error statistics are stored.

A method is advantageously employed in which, in addition to the identifier, the error statistics are stored in the at least one storage means.

A method is advantageously employed in which the identifier is written by at least one processing unit, and the error status by the comparison unit and/or the switchover unit, into the storage means.

A method is advantageously employed in which the data are buffered prior to being input into the comparison means.

A method is advantageously employed in which a source, in particular a processing unit, that is internal to the computer system, specifies the identifier used for setting the voting.

A method is advantageously employed in which a source that is external to the computer system, specifies the identifier used for setting the voting.

A method is advantageously employed in which a plurality of sources is provided for specifying the identifier, and all sources are linked in such a way that the setting of the voting is configured by an OR operation.

A device for performing switchover operations and for comparing data in a computer system having at least three processing units is advantageously provided in accordance with the present invention, switchover means being provided, and switchover operations being carried out between at least two operating modes, comparison means being provided, and a first operating mode corresponding to a comparison mode, and a second operating mode corresponding to a performance mode, characterized in that provision is made in the comparison mode for a voting scheme, at least as a two-out-of-three weighting, control means being included which may be used to set the voting.

A device is advantageously provided in which the control means at least include storage means or are designed as such, and an identifier for setting the voting, in particular a bit, is stored in the storage means.

A device is advantageously provided in which the storage means is at least a control register.

A device is advantageously provided in which the at least one input buffer memory is provided, which is designed in such a way that the data are buffered prior to being input into the comparison means.

A device is advantageously provided in which the control means are provided as a source for setting the voting externally to the computer system.

A device is advantageously provided in which the control means are provided as a source for setting the voting internally to the computer system.

A device is advantageously provided in which all sources for setting the voting are linked in such a way that the setting of the voting is configured by an OR operation.

### BRIEF DESCRIPTION OF THE SEVERAL VIEWS OF THE DRAWING

FIG. 1 shows the basic function of a switchover and comparison unit for two processing units.

FIG. 1a shows a generalized representation of a comparator.

FIG. 1c shows an expanded representation of a comparator.

FIG. 1b shows a generalized representation of a switchover and comparison unit.

FIG. 2 shows a more detailed representation of the switchover and comparison unit for two processing units.

FIG. 3 shows one example implementation of a switchover and comparison unit for two processing units.

FIG. 4 shows a more detailed representation of a switchover and comparison unit for more than two processing units.

FIG. 5 shows one example implementation of a switchover and comparison unit for more than two processing units.

FIG. 6 shows one example implementation of a control register.

FIG. 7 shows a voting unit for centralized voting.

FIG. 8 shows a voting unit for decentralized voting.

FIG. 9 shows a synchronization element.

FIG. 10 shows a handshake interface.

FIG. 11 shows a differential amplifier.

FIG. 12 shows a comparator for a positive voltage difference.

FIG. 13 shows a comparator for a negative voltage difference.

FIG. 14 shows a circuit for storing an error.

FIG. 15 shows an analog-to-digital converter having an output register.

FIG. 16 shows a representation of a digitally converted analog value having an identifier and analog bit.

FIG. 17 shows the representation of a digital value as a digital word including a digital bit.

### DETAILED DESCRIPTION OF THE INVENTION

In the following, an execution unit or processing unit may denote both a processor/core/CPU, as well as an FPU (floating point unit), a DSP (digital signal processor), a co-processor or an ALU (arithmetic logical unit).

A system having two or more processing units is considered. In principle, safety-critical systems provide the option of using such resources to enhance performance by assigning different tasks to the various processing units to the greatest extent possible. Alternatively, some of the resources may also be used redundantly relative to one another, by assigning the same task to them and recognizing an error in the case of a disparate result.

Depending on how many processing units there are, a plurality of modes is conceivable. In a two-unit system, the two modes “comparison” and “performance” exist, as described above. In a three-unit system, besides the pure performance mode in which all three processing units work in parallel, and the pure comparison mode, in which all three processing units calculate redundantly and a comparison is made, it is also possible to realize a 2-out-of-3 voting mode, in which all three processing units calculate redundantly and a majority selection is made. In addition, a mixed mode may be realized as well in which, for instance, two of the processing units calculate redundantly in relation to one another, and the results are compared, while the third processing unit executes a different, parallel task. In a four or more processing-unit system, it is self-evident that still other combinations are conceivable.

The objective to be achieved is to enable the available processing units in a system to be used in a variable manner during operation, without necessitating an intervention in the existing structure of these processing units (for example, for synchronization purposes). One example embodiment provides for each processing unit to be able to operate at its own clock pulse, i.e., be able to execute the same tasks for comparison purposes asynchronously in relation one another as well.

This objective is achieved by producing a universal, widely usable IP, which allows the operating modes (for example, comparison mode, performance mode or voting mode) to be switched at any desired point in time without switching off the processing units in advance, and manages the process of comparing or voting of the possibly mutually asynchronous data streams. This IP may be designed as a chip, or it may be integrated on one chip, together with one or more processing units. In addition, it is not required that this chip be made from only one piece of silicon; it is entirely possible that it be made from separate components as well.

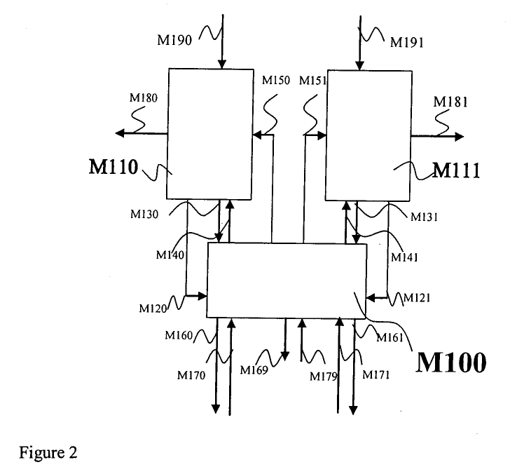

To ensure synchronous operation among various processing units, signals are required that prevent execution of the programs of individual processing units from continuously advancing. To that end, a WAIT signal is typically provided. If an execution unit does not have a wait signal, it may also be synchronized via an interrupt. For this purpose, the synchronization signal (for example, M140 in FIG. 2) is not transmitted to a wait input, but applied to an interrupt. This interrupt must have a high enough priority over the processing program and also over other interrupts, in order to interrupt the normal mode of operation. The associated interrupt routine executes only a certain number of NOPs (blank instructions having no effect on data), before the system returns to the interrupted program, thereby delaying further processing of the processing program. In some instances, during the interrupt routine, the usual storage operations must still be performed at the beginning and at the end, to ensure that the normal program processing is not impaired by the interrupt.

This procedure is continued until synchronous operation is established (for example, other processing units deliver the expected comparative data). However, this method is only able to conditionally ensure a precise clock synchronism and, in particular, phase equality with other processing units. Thus, when using the interrupt signal for synchronization purposes, it is recommended that the data to be compared be buffer-stored in the SCU switchover and comparison unit before they are compared.

The present invention advantageously permits the use of any commercially available standard structures because no additional signals are required (no interventions in the hardware structure), and any given output signals from these components, used, for example, to directly control actuators, may be monitored. This includes the checking of converter structures, such as DACs and PWMs, which, previously under the related art, have not been able to be directly checked in this manner using a comparison process.

To the extent that there is no need to check individual tasks or SW tasks, however, the switch may also be made to a performance mode in which different tasks are distributed among various processing units.

Another advantage is derived in that, in a comparison or voting mode, there is no need for all of the data to be compared. Only the data to be compared or voted are synchronized with one another in the switchover and comparison unit. The process of selecting these data may be variable (programmable) because of the selective response of the switchover and comparison unit, and it may be adapted to the particular processing unit architecture, as well as to the application. Thus, diverse SCs or software components may also be readily used, since only results which lend themselves to a meaningful comparison, are also actually compared.

Thus, in addition, every access to a (for example, external) memory or also only the control of external I/O modules may be monitored. Internal signals may be checked via the software-controlled additional output to the switchover module on the external data bus and/or address bus.

All control signals for the comparison operations are generated in the preferably programmable switchover and voting unit, and the comparison takes place there as well. The processing units (for example, processors), whose outputs are to be compared with one another, may use the same program, a duplicated program (which additionally allows the detection of errors during memory access), or also a diversified program, to detect software errors. In the process, there is no need for all of the signals supplied by the processing units to be compared with one another; rather, an identifier (address signal or control signal) may also be used to designate or not designate certain signals for the comparison. This identifier is evaluated in the switchover and comparison device, thereby permitting control of the comparison operation.

Separate timers monitor deviations in the time response beyond a specifiable limit. Some or even all of the modules of the switchover and comparison unit may be integrated on one chip, accommodated on one common board or even in a spatially separate manner. In the latter case, the data and the control signals are exchanged via appropriate bus systems. Local registers are then written via the bus system and control the procedures by way of the data signals and/or address/control signals stored therein.

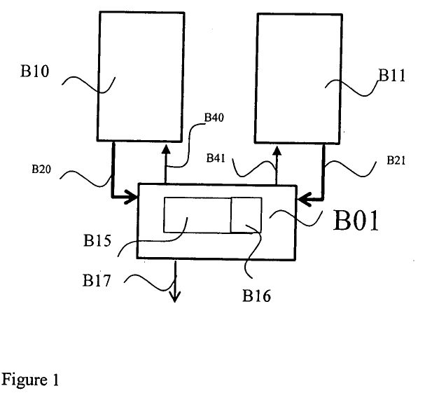

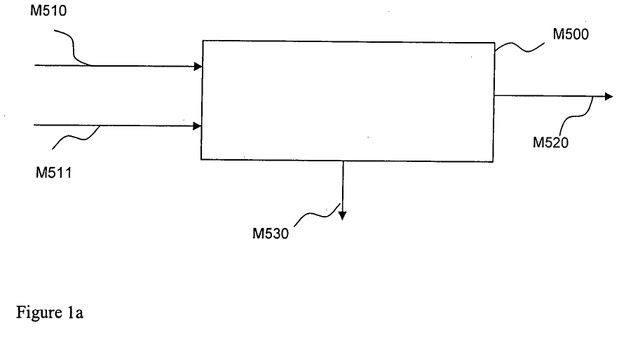

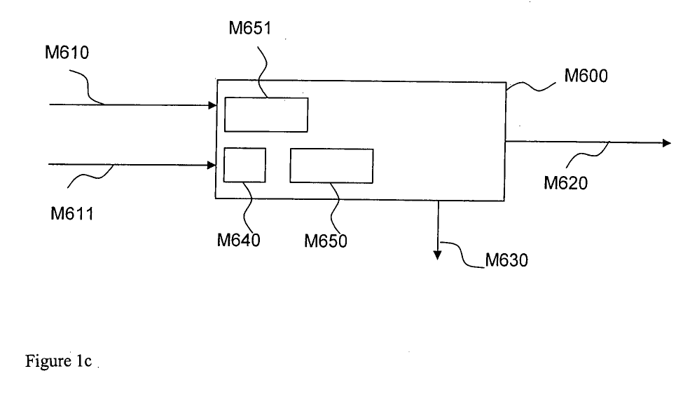

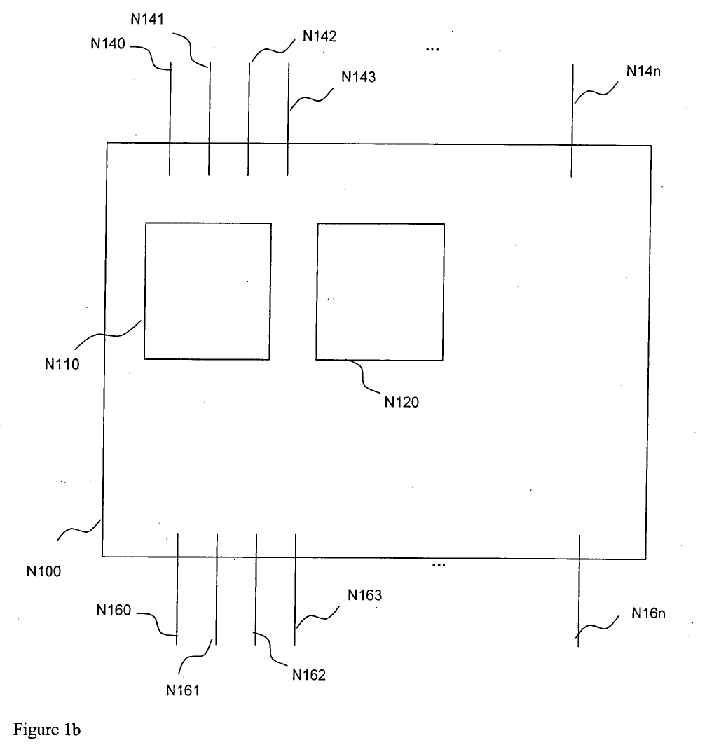

FIG. 1 shows the basic function of switchover unit B01 according to the present invention for use in connection with two processing units B10 and B11. Various output signals, such as data, control and address signals B20 or B21 of processing units B10 and B11, communicate with switchover unit B01. Moreover, there is at least one synchronization signal, in the embodiment of the system according to the present invention, the two output signals B40 and B41, which communicates with one of the comparison units.

The switchover unit includes at least one control register B15, which has at least one memory element for a binary digit (bit) B16, which switches the mode of the comparison unit. At the least, B16 may assume the two values 0 and 1, and may be set or reset by signals B20 or B21 of the processing units or by internal processes of the switchover unit.

If B16 is set to the first value, then the switchover unit operates in the comparison mode. In this mode, all data signals incoming from B20 are compared to the data signals from B21, provided that certain specifiable comparison conditions of the control and/or address signals from signals B20 and B21 are met, which signal the validity of the data and the comparison specified for these data.

If these comparison conditions are simultaneously met for both signals B20 and B21, then the data from these signals are immediately compared, and, in the case of disparity, an error signal B17 is set. If only the comparison condition from either signals B20 or B21 is met, then the appropriate synchronization signal B40 or B41 is set. This signal has the effect of stopping the processing in the corresponding processing unit B10 or B11, and thus prevents onward propagation of the corresponding signals that, so far, have not been able to be compared with one another. Signal B40 or B41 remains set until the comparison condition in question of the other respective processing unit B21 or B20 is met. In this case, the comparison operation is performed, and the corresponding synchronization signal is reset.

To ensure the comparison in the case that the two processing units supply the data to be compared non-simultaneously, as described, it is either necessary that the data and comparison conditions of the respective processing unit be held to the corresponding values until the corresponding synchronization signal B40 or B41 has been reset, or that the data provided first in the switchover unit be stored until the comparison takes place.

The processing unit that is the first to make data available must wait before continuing to execute its program or its processes until the other processing unit supplies the corresponding comparison data.

One example embodiment of the switchover unit according to FIG. 1 provides that one of signals B40 or B41 may be omitted if it is always ensured that the associated processing unit does not supply comparison data before the other processing unit.

If B16 is set to the second value, then synchronization signals B20 and B21, as well as error signal B17 are always inactive and are set to value 0, for example. Also, no comparison is carried out, and the two processing units operate independently of each other.

In the system according to the present invention, the comparator is an essential component. It is shown in its simplest form in FIG. 1a. Comparator component M500 is able to receive two input signals M510 and M511. It then compares them for parity, in the context described here, e.g., in the sense of a bit parity. If it detects disparity, error signal M530 is activated, and signal M520 is deactivated. In the case of parity, the value of input signals M510, M511 is applied to output signal M520, and error signal M530 does not become active, i.e., it signals the status “good.” Using this basic system as a point of departure, a multiplicity of broadened specific embodiments is conceivable. To begin with, component M500 may be designed as a so-called TSC component (totally self checking). In this case, error signal M530 is routed to the outside via at least two lines (“dual rail”), and internal design and fault detection measures ensure that this signal is present in a correct or identifiably incorrect form in every possible case involving a fault of the comparator component. One example embodiment for using the system according to the present invention provides for such a TSC comparator to be used.

A second kind of example embodiment may be distinguished by the degree of synchronism required of the two inputs M510, M511 (or M610, M611). One possible variant is characterized by clocked synchronism, i.e., the process of comparing the data may be carried out using one clock pulse. A slight variation arises when, given a fixed phase displacement between the inputs, a synchronous delay element is used, which delays the corresponding signals by whole numbered or even half clock pulse periods, for example. Such a phase displacement is useful in avoiding common cause errors, i.e., errors which can simultaneously affect a plurality of processing units. For that reason, over and above the components from illustration M5, component M640, which delays the earlier input by the phase displacement, is introduced in FIG. 1c. This delay element is preferably accommodated in the comparator, in order that it be used only in the comparison mode. Alternatively or additionally, intermediate buffers may be placed in the input chain, to enable asynchronous operations to be tolerated as well. They are preferably designed as FIFO memories. If such a buffer is present, then asynchronous operations may also be tolerated up to the maximum depth of the buffer. In such a case, an error signal must also be output when the buffer overflows.

Moreover, in the comparator, example embodiments may be differentiated by the manner in which signal M520 (or M620) is generated. One preferred specific embodiment provides for applying input signals M510, M511 (or M610, M611) to the output and for the connection to be interruptible by switches. The special advantage of this variant is that the same switches may be used for switching between the performance mode and possible different comparison modes. Alternatively, the signals may also be generated from buffer memories that are internal to the comparator.

One last kind of example embodiment may be differentiated by how many inputs are present at the comparator and by how the comparator is to react. In the case of three inputs, a majority voting, a comparison of all three, or a comparison of only two signals may be undertaken. In the case of four or more inputs, an equivalent number of more variants is conceivable. Preferably, these variants are to be coupled to the various operating modes of the overall system.

To explain the general case, FIG. 1b shows a generalized representation of a switchover and comparison unit, as it preferably should be used. Of the n execution units to be considered, n signals N140, . . . , N14n are transmitted to switchover and comparison component N100. From these input signals, this component is able to generate up to n output signals N160, . . . , N16n. In the simplest case, the “pure performance mode,” all signals N14i are routed to the corresponding output signals N16i. In the opposite limiting case, the “pure comparison mode,” all signals N140, . . . , N14n are routed to only precisely one of output signals N16i.

This figure illustrates how the various conceivable modes may be produced. To this end, the logic component of a switching logic N110 is included in this figure. The component, as such, need not exist. It is merely important that its function be present. To begin with, it specifies how many output signals there actually are. In addition, switching logic N110 specifies which input signals contribute to which one of the output signals. In this context, one input signal may contribute to precisely one output signal. Formulated mathematically, the switching logic thus defines a function that assigns one element of set {N160, . . . , N16n} to each element of set {N140, . . . , N14n}.

For each of outputs N16i, the function of processing logic N120 then establishes in which form the inputs contribute to this output signal. This component, as well, does not necessarily need to be present as a separate component. Decisive, again, is that the described functions be implemented in the system. To describe the different possible variations exemplarily, it is assumed, without limiting universality, that output N160 is generated by signals N141, . . . , N14m. If m=1, this simply corresponds to the signal being switched through; if m=2, then signals N141, N142 are compared. This comparison may be implemented synchronously or asynchronously; it may be performed on a bit-by-bit basis, or only for significant bits or also using a tolerance range.

In the case that m≧3, a plurality of options is provided.

One first option provides for comparing all of the signals, and, in response to the existence of at least two different values, for an error to be detected, which may optionally be signaled.

A second option provides for making a k-out-of-m selection (k>m/2). This may be implemented through the use of comparators. An error signal may be optionally generated if it is ascertained that one of the signals is deviant. A possibly differing error signal may be generated when all three signals are different.

A third option provides for supplying these values to an algorithm. This may take the form of generating an average value, a median value, or of using a fault-tolerant algorithm (FTA), for example. Such an FTA is based on deletion of the extreme values of the input values and on a type of averaging of the remaining values. This averaging may be performed for the entire set of the remaining values or for a subset that is easily formed in HW. In such a case, it is not always necessary to actually compare the values. In the averaging operation, it is merely necessary to add and divide, for example; FTM, FTA or median value generation require partial sorting. If appropriate, here, too, a fault signal may optionally be output, given sufficiently high extreme values.

For the sake of brevity, these various mentioned options for processing a plurality of signals to form one signal are described as comparison operations.

Thus, the task of the processing logic is to establish the exact form of the comparison operation for each output signal, and thus also for the corresponding input signals. The combination of the information of switching logic N110 (i.e., the function named above) and of the processing logic (i.e., the establishment of the comparison operation per output signal, i.e., per functional value) is the mode information, and this determines the mode. Generally, this information is naturally multi-valued, i.e., not representable by only one logic bit. Not all theoretically conceivable modes are practical in a given implementation; the number of permitted modes generally will be limited. It is important to note that, in the case of only two execution units, where there is only one comparison mode, the entire information may be condensed into only one logic bit.

A switch from a performance mode to a comparison mode is generally characterized in that execution units, which, in the performance mode, are mapped to different outputs, are mapped to the same output in the comparison mode. This is implemented in that a subsystem of execution units is provided, in which, in the performance mode, all input signals N14i, which are to be considered in the subsystem, are directly switched to corresponding output signals N16i, while, in the comparison mode, they are all mapped to an output. Alternatively, such a switchover operation may also be implemented by altering pairings. The explanation for this is that, generally, it is not possible to speak of the performance mode and the comparison mode, although, in one example embodiment of the present invention, the number of permitted modes may be limited in such a way that this general case does apply.

However, it is always possible to speak of a switch from a performance mode to a comparison mode (and vice versa).

Software-controlled switchover operations between these modes may be dynamically carried out during operation. In this context, the switchover operation is triggered by the execution of special switchover instructions, special instruction sequences, explicitly identified instructions or in response to the accessing of specific addresses by at least one of the execution units of the multiprocessor system.

A two-processor system or a two μC system that includes a switchover and comparison unit M100 according to the present invention is shown in greater detail in FIG. 2, where different ones of the sketched signals may be optionally omitted as well. It is composed of two processing units (M110, M111) and of one switchover and comparison unit M100. Each processing unit transmits data signals (M120, M121) and address/control signals (M130, M131) to the switchover unit, and, in return, each processing unit optionally receives data (M150, M151) and control signals (M140, M141) from the switchover unit, as well. Unit M100 outputs data (M160, M161) and status information M169 and receives signals, such as data (M170, M171) and control signals M179, which may also be routed to the processing units. The operating mode of unit M100 may be optionally set as well via M170, M171 and M179, independently of the processing units; likewise, the processors may set the operating mode in unit M100 via outputs M120, M121 (e.g. data bus) and control and address signals M130, M131 (e.g. write), for instance, performance mode (without comparison) or comparison mode (with comparison of signals M120, M121 and/or signals M170, M171, which may, for example, come from peripheral units). In the performance mode, outputs M120, M121, possibly in conjunction with control signals, are routed to outputs M160, M161, and, conversely, inputs M170, M171 to M150, M151. In the comparison mode, the outputs are compared and, only in the error-free case, advantageously routed to M160, M161, both outputs being optionally used, or only one of the two. Likewise possible is a verification of input data M170, M171, which are routed to the processing units. In the case of an erroneous comparison of the signals in the comparison mode, an error signal is generated and signaled to the outside (component of status information M169), for instance, using double-rail signals: fail-safe. Status M169 may also include the operating mode or information pertaining to the time lag of the signals of the execution units. In the case that the comparison data of a processing unit are not made available within a specified (programmable) time interval, the error signal is also activated. In the case of an error, outputs M160, M161 may be blocked (fail-silent behavior). This may affect digital as well as analog signals. However, these output driver stages may also output the undelayed (not buffer-stored) output signals M120, M121 of a processing unit, with the possibility of subsequent error detection. This is tolerated by a safety-related system, as long as the error tolerance time is not exceeded, i.e., the time in which an (inert) system does not yet react catastrophically to errors, so that a correction is still possible.

Output signals M180, M181, which are not directed into the SCU, and internal signals of a processing unit may also be compared, at least with respect to their calculated value, by outputting this value to outputs M120, M121 for the purpose of comparison. Equivalent processes may also be carried out using input signals M190, M191, which do not arrive via M100.

To monitor unit M100, it may be possible for selected signals or also for all signals M160, M161 to be read back via M170, M171 or also via M190, M191. This makes it possible to ensure in the comparison mode as well, that faulty signals from unit M100 are detected. Thus, using a suitable disabling path, to which M100, M110, M111 have access (in an OR operation), a fail-silence behavior of the entire system may be established.

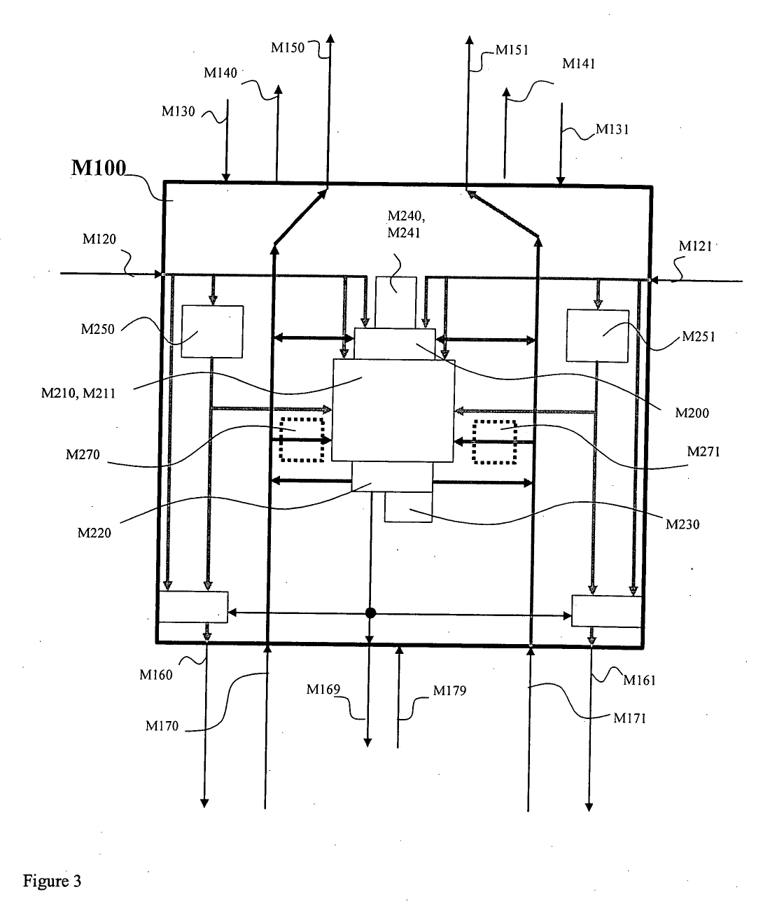

One possible implementation of switchover and comparison unit M100 of FIG. 2 is shown in detail in FIG. 3. Unit M100 includes a control register M200 having at least one bit, which represents the mode (performance/comparison), and a status register M220 having at least one bit which represents the fault condition in the comparison mode. The wait and interrupt signals are controlled by other bits in the control register for both processing units, respectively. In the process, the need may arise to distinguish among different interrupts, such as for synchronization purposes, to prepare for switching the operating modes, and for handling faults.

Optionally, there may be additional control registers, such as M240, that includes the maximum allowable time difference (in number of clock pulses) between the processing units for triggering an internal or external watchdog, as well as M241 having the time difference value (number of clock periods) above which the fastest processor is to be intermittently stopped or delayed by WAIT or interrupt signals, in order, for example, to prevent data registers from overflowing.

Also stored in status register M220, for example, besides the error bit, is the magnitude of the current clock pulse offset between the processing units. To that end, at least one timer M230 is always started by a processing unit, for example, whenever a data value specially marked (by address and control signals, for instance a specific address range) is first made available, and the value of the timer is clocked into the status register whenever the data value in question is made available by the second processing unit. Moreover, the timer is preferably set in such a way that, even when working with different program flows, corresponding to the WCET (worst case execution time), it is ensured that all processing units must supply one piece of data. In the case that the specified value is exceeded by the timer, an error signal is output.

In M100, outputs M120, M121 of the processing units are to be stored in a buffer memory M250, M251, in particular for the comparison mode, provided that digital data are concerned and they are not able to be supplied in a process that maintains clock accuracy. This memory may be designed as a FIFO. If this memory has a depth of only one (register), then it must be ensured through the use of wait signals, for example, that the outputting of additional values is delayed until the comparison process has taken place, in order to avoid a loss of data.

In addition, there is a comparator unit M210, which compares the digital data from input memories M250, M251, and direct inputs M120, M121 or M170, M171 with one another. This comparison unit is also able to compare serial digital data (for example, PWM signals) with one another, when, for example, the serial data are able to be received in memory unit M250, M251 and converted into parallel data, which are then compared in M210. In the same way, asynchronous digital input signals M170, M171 are able to be synchronized via additional memory units M270, M271. As is also the case for input signals 120, 121, these are buffer-stored in a FIFO. The switch between the performance mode and comparison mode is accomplished by setting or resetting the mode bit in the control register, thereby causing corresponding interrupts, for example, in the two processing units. The comparison itself is induced by the supplied data M120, M121, as well as the associated addresses and control signals M130, M131. In the process, specific signals from M120 and M130 or M121 and M131 may function as identifiers which indicate whether the assigned data are to be compared.

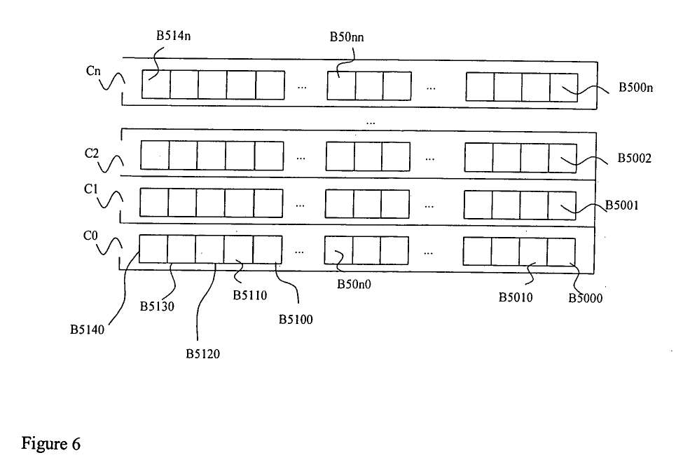

This example embodiment is a continuation of the simple switchover configuration in FIG. 1. In this case, the interrupt routines are used to advantageously make various preparations when the transition is made to a comparison mode, in order to create identical initial conditions for both processing units. If the processing unit is finished with this process, it sets the processor-specific ready bit in the control register, and the processing unit remains in the wait state until the other processing unit, by its ready bit, signals its readiness as well (see also the description of the control register in FIG. 6).

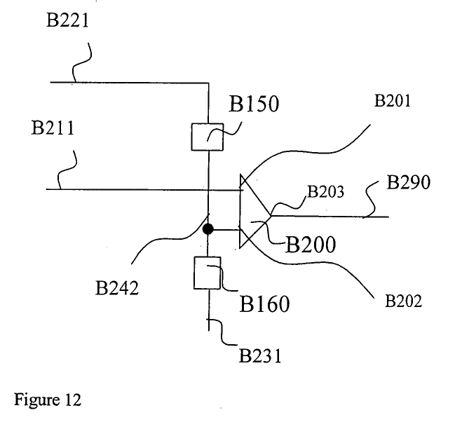

In this comparison unit, analog data may likewise be compared with one another in an analog comparison unit M211 specially suited for this purpose. However, this presupposes that the analog signals are output synchronously enough with respect to one another, or that provision is made for the data digitized by an ADC implemented in the analog comparison unit to be stored in the same (in this regard, see further explanations regarding FIGS. 12 through 14). Synchronous operation is able to be achieved by comparing the digital outputs of the processing units (data, address and control signals) with one another, as described above, and by allowing that processing unit, which is too fast, to wait. For this purpose, the digital signals, which are processed as a source of the analog signals in the processing unit, may also be transmitted to unit M100 via outputs M120, M121, although these signals are otherwise not needed externally. This redundant comparison, in addition to the process of comparing the analog signals, ensures that an error in the computation may be detected already at an earlier point in time. In addition, this facilitates the process of synchronizing the processing units. The process of comparing the analog signals results in an additional error detection for the DAC (digital to analog converter) of the processing unit. Such a possibility is not given in other structures of the DCSL architectures. A comparison is also possible for analog input signals from the peripheral units. In particular, when it is a question of redundant sensor signals of the same system parameter, no additional synchronization measures are required, rather, in some instances, only a control signal indicating the validity of the sensor signals. The implementation of a comparison of analog signals will be still be shown in detail.

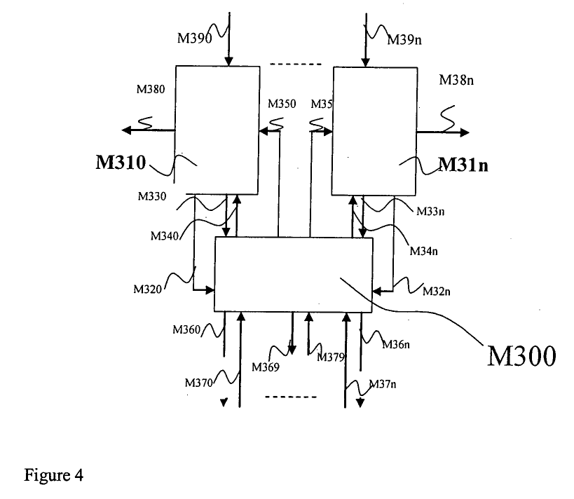

FIG. 4 shows a multiprocessor system having at least n+1 processing units, each of these components also being able to be composed, in turn, of a plurality of sub-processing units (CPUs, ALUs, DSPs having corresponding additional components). The signals from these processing units communicate with a switchover and comparison unit in precisely the same manner described for the two-unit system according to FIG. 2. Therefore, with respect to content, all of the components and signals in this figure have the same significance as the corresponding components and signals in FIG. 2. Switchover and comparison unit M300 is able to distinguish in the multiprocessor system among the performance mode (all of the processing units execute different tasks), the various comparison modes (the data of two or even more processing units are to be compared and, in the case of deviations, an error is to be signaled), and the various voting modes (majority decision in the case of a deviation, in accordance with different specifiable algorithms). For each processing unit, a separate decision may be made as to which mode it is operating in and with which other processing units it is possibly operating together in these modes. The precise manner in which the switchover operation is carried out is described below following the description of the control registers according to FIG. 6.

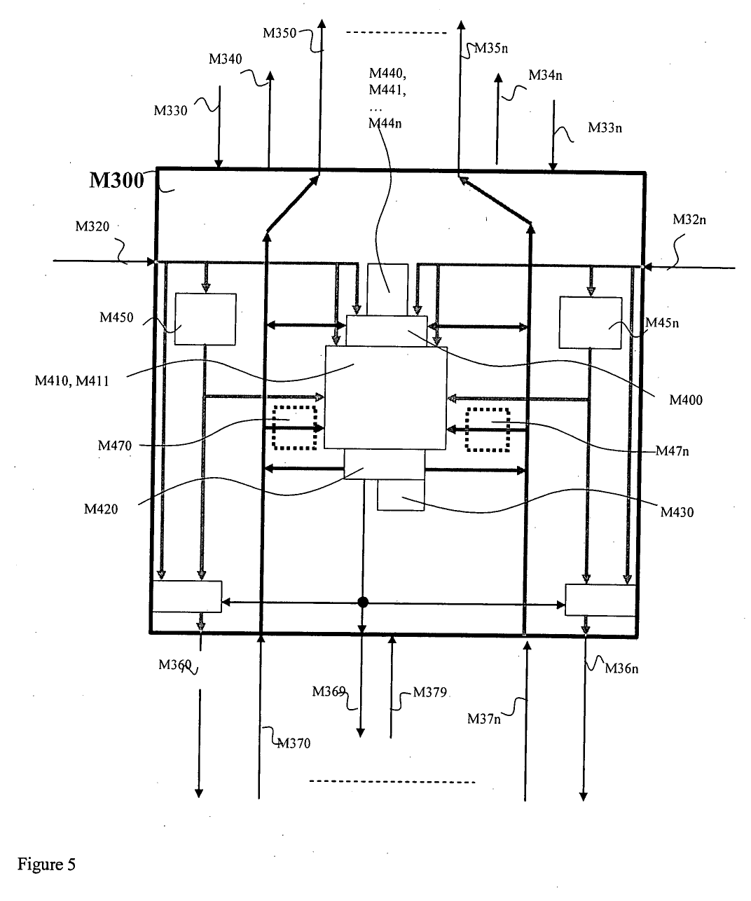

FIG. 5 shows one example implementation of a switchover unit for a multiprocessor system having n+1 processing units. For each processing unit, at least one control register M44i is provided in the control unit of the switchover and comparison module. One example set of control registers is shown and described in detail in FIG. 6. In this context, M44i corresponds in each instance to control register Ci.

Various example embodiments in the control register are conceivable. Suitable bit combinations may be used to describe whether an error detection pattern or an error tolerance pattern should be used. Depending on the degree of complexity of unit M300, the type of error tolerance pattern (2 out of 3, median, 2 out of 4, 3 out of 4, FTA, FTM . . . ) to be used, may be additionally specified. In addition, a configurable design is possible as to which output is to be switched through. Accordingly, one may then devise example embodiments as well, as to which components may influence this configuration for which piece of data.

The output signals from the processing units involved are then compared to one another in the switchover unit. Since the signals are not necessarily processed in a process that maintains clock accuracy, the data must be buffer-stored. In the process, data may also be compared in the switchover unit that are transmitted at a greater time difference by the various processing units to the switchover unit. Using a buffer store (in the form of a FIFO memory, for instance: first in-first out, or in a different buffer form as well), a plurality of data may also first be received by one processing unit, while other processing units are not making any data available yet. In this context, a measure of the synchronous operation of the two processing units is the occupancy level of the FIFO memory. If a specific, predefinable occupancy level is exceeded, then the processing unit that is the furthest advanced in the processing is intermittently stopped, either by an existing WAIT signal or by suitable interrupt routines, in order to wait for the processing units that are not advancing as quickly in the processing. In the process, the monitoring should be extended to include all externally available signals of a processing unit; this includes analog signals or PWM signals as well. This requires that structures that permit a comparison of such signals be provided in the switchover unit. Moreover, it is provided that a maximum time deviation be specified among the data to be compared and that it be monitored using at least one timer.

If, generally, more than two processing units are linked to one another by one shared switchover unit, then one control register is required for each of these processing units. One special design of these control registers is clarified in FIG. 6.

The (n+1) low-order bits B500x through B5Onx of the particular control register Cx are uniquely assigned to the n+1 processors/processing units. Bit B514x of control register Cx switches between comparison/voting, on the one hand, and parallel operation, on the other hand, and corresponds to the value of B16 from FIG. 1. Bit B513x indicates whether the processing unit in question is ready for the comparison process (ready); bit B512x controls the synchronization signal (WAIT or INTERRUPT); and bit B511x may be used to prepare processing unit x in question for the comparison process via an interrupt. Accordingly, bit B5110x controls an interrupt, which switches the processing unit back into the parallel mode.

If B5Oik and B5Okk of control register Ck are set to one (0≦i, k≦n), then, in this specific embodiment, this means that the outputs of processing unit i are to be compared with those of processing unit k. If, in addition, B50jk is also equal to 1, then voting is to take place among i, j and k, and the voting result is output at output k of the SCU (0≦i, j, k≦n). To this end, for each group of processing units, a special type of voting or also of only a majority comparison, may be established, as explained previously with respect to illustration M4. Generally, all bits B50ik must be set for processing units i to be compared/voted (in control register Ck), when the voting result is to be output at output k of the SCU. A parallel outputting to other outputs is possible.

A one in B50ii of control register i (0≦i, ≦n) indicates that output i of the comparison unit is supposed to be active. If all control registers Ci carry a one (i=0, 1, . . . n) only in the corresponding memory locations B50ii, then all of the processing units are working in the performance mode using any given different programs and their own output signals. If all of the n+1 low-order bits B5Oik are equal to one (i=0, 1, . . . n), and, moreover, B514k is set, then the output signals of all processing units are selected by majority decision (voting) and output to output k of the SCU; in the case of n=1, only one comparison is made.

The following describes exemplarily how a sequence might appear when the transition is made to a comparison/voting in a system having a plurality of processing units.

Bit B514i in control register Ci is set in order to activate the comparison or the voting process. This bit may be set by the processing unit itself, as well as by the switchover and comparison unit, as a function of specific system states, time conditions or other conditions (such as accesses to certain memory areas, errors or implausibilities). If, in response to B514i, bits B5Oii and B5Oki are set, then bits B511i and B511k are automatically set by the SCU, thereby triggering interrupts in processing units i and k. These interrupts cause the processing units to jump to a certain program location, certain initialization steps to be carried out for the transition to the comparison mode, and for an acknowledgment (ready) to then be output to the switchover and comparison unit. The ready signal causes interrupt bit B511i in control register Ci in question of the processing unit to be automatically reset and, at the same time, for wait bit B512i to be set. When all of the wait bits of the processing units taking part have been set, they are simultaneously reset by the switchover and comparison unit. The processing units then begin with the process of executing the program parts to be monitored. In accordance with one advantageous embodiment, writing to a control register Ci having a set bit B514i is prevented by locking (HW or SW). This has the practical effect of ensuring that the configuration of the comparison cannot be changed during execution. A change in control register Ci is only possible after bit B514i has been reset. This resetting process produces interrupts in the respective processing units by setting bits B510x in the control registers of all participating processing units for the transition to the normal mode (parallel mode of operation).

The consistency of all control registers with respect to one another is monitored in accordance with user specifications, and, in the case of an error, an error signal is generated which constitutes part of the status information. Thus, for example, a processing unit must not be used simultaneously for a plurality of independent comparison or voting processes, because, then, synchronization will not be ensured. Conceivable, however, is a comparison of even a plurality of processing units, without outputting of the data signals, but rather only for the purpose of generating an error signal in the case of disparity.

Another example embodiment provides that the entry in a plurality of or all control registers of the processing units participating in a comparison or a voting be made in a substantially identical fashion, i.e., the corresponding bits of these processing units are to be set there in a substantially identical fashion, in some instances with the exception of their own bit i, which controls the output.

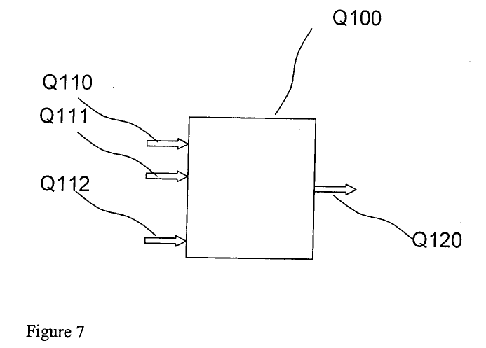

FIG. 7 shows voting unit Q100 for centralized voting. Voting may be carried out both by using suitable hardware, as well as software. The voting algorithm (e.g. bit-precise voting) is to be specified for this. In this context, voting unit Q100 receives a plurality of signals Q110, Q111, Q112 and, from these, generates an output signal Q120, which is formed by voting (for example, an m out of n selection).

If an error occurs in the comparison, the error bit is set in the respective control register. In a voting process, the piece of data of the respective processing unit is ignored; in a simple comparison, the output is blocked.

All data which are not available in time, before expiration of the programmed time, are treated as errors. The resetting of the error bits takes place as a system-dependent process and, if indicated, allows a reintegration of the processing unit in question.

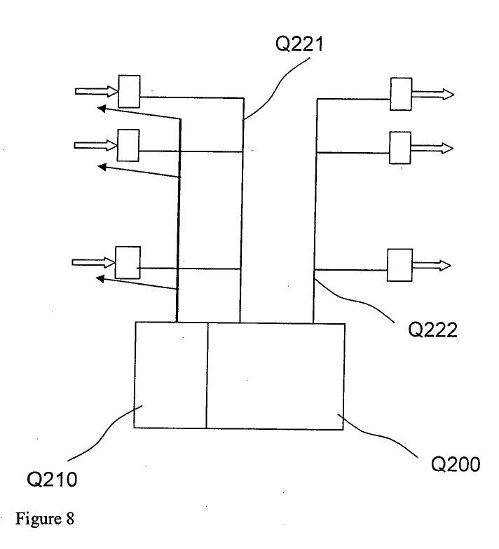

In the case that the processing units and/or the voter are not spatially concentrated, a decentralized voting is also possible, in connection with a suitable bus system according to FIG. 8. In FIG. 8, a decentralized voting unit Q200 is controlled by a control unit Q210. It is linked via bus systems Q221, Q222, receives data via these bus systems, and outputs them there again as well.

The resetting of the comparison and voting bit in a control register having an active output bit produces an interrupt in the participating processing units, which are then returned to a parallel mode of operation again. Each processing unit may have a different vector address, which is administered separately. The program processing may then also be implemented via the same program memory. However, the accesses are separate and, typically, to different addresses. If the security-relevant part is negligible in comparison to the parallel modes, it should be considered whether a dedicated program memory having a duplicated security part would perhaps require less expenditure.

The data memory as well may be shared in the performance mode. The accesses then take place sequentially, using the AHB/ABP bus, for example.

As a special feature, it also should be mentioned that the error bits must be analyzed by the system. To ensure reliable deactivation in the case of an error, the security-relevant signals should be implemented redundantly in a suitable form (for instance, in the one-of-two code).

In the existing SCUs in accordance with FIGS. 1, 2, 3, 4 and 5, the initial assumption was that the processing units work with clock pulses that are the same or that are derived from one another, and which are in a constant phase relation with one another. If clock pulses from various oscillators and generators, whose phase relations change, are also used for the processing devices, then the signals generated in the process must be synchronized when they change clock domains.

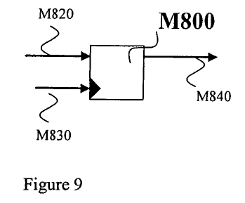

To this end, a synchronization element M800 is shown in FIG. 9. In order to reliably store and compare the digital data, in particular, synchronization devices M800 are then required, which may be placed at any location in the signal flow. These ensure, for one, that data M820 are stored using clock pulse M830 of the processing unit which supplies these data. The reading process employs the clock pulse which is used for further processing of piece of data M840. Such a synchronization stage M800 may be designed as a FIFO, to enable a plurality of data to be stored (see FIG. 9) Generally, synchronization of the data alone does not suffice, rather the provisioning signal of the data must also be synchronized with the receiver clock.

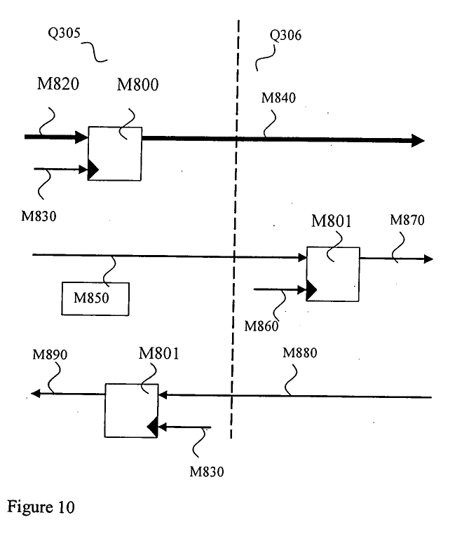

Moreover, a handshake interface is required (FIG. 10), which, via request signals M850 and acknowledge signals M880, ensures the transfer. Such an interface is required whenever the clock domain changes, in order to ensure reliable transmission of the data from one clock domain to the other. During the write process, data M820 from area Q305 are made available in register cells M800 in synchronized form, using clock pulse M830, and a write request signal M850 indicates the provisioning of the data. This write request signal is transferred using clock pulse M860 from area Q306 into a memory element M801 and, as synchronized signal M870, it indicates the provisioning of the data. Synchronized piece of data M840 is then clocked in at the next active clock pulse edge of clock pulse M860, and a confirmation signal M880 is sent back in the process. This confirmation signal is synchronized by clock pulse M830 in a further memory element M801 to form signal M890, and the process of provisioning the data is thereby ended. New data may then be written into the register in question. Such interfaces are known in the art and, in certain embodiments, they are able to work very rapidly by employing an additional encoding, without having to wait for an acknowledge signal.

In one example embodiment, memory elements M800 are designed as FIFO memories (first in, first out).

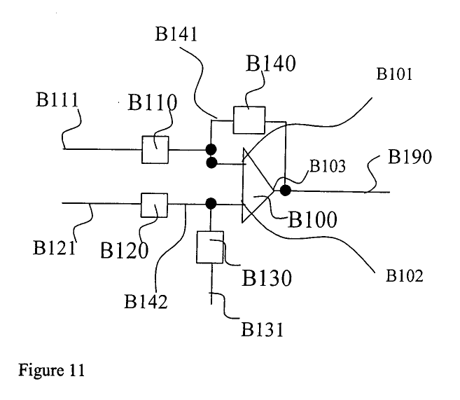

In the case of the circuits used to compare the analog signals of FIG. 11 through FIG. 14, the assumption is made that the processing units, which supply the analog signals to be compared, are synchronized with one another in such a way that the comparison is useful. The synchronization may be accomplished by the corresponding signals B40 and B41 of FIG. 1.

FIG. 11 shows a differential amplifier. This element may be used to compare two voltages with one another.

In this context, B100 is an operational amplifier, to whose negative input B101 a signal B141 is switched through, which is linked via a resistor B110 having value Rᵢₙ to input signal B111, at which voltage value V₁ is present. Positive input B102 is connected to signal B142, which is connected via resistor B120 having value Rᵢₙ to input B121, at which voltage value V₂ is present. Output B103 of this operational amplifier is connected to output signal B190 which has voltage value Vₒᵤₜ. Signal B190 is connected via resistor B140 having value R_{f} to signal B141, and signal B142 is connected via resistor B130 having value R_{f} to signal B131, which has the voltage value of analog reference point V_{agnd}. The output voltage may be calculated according to the following formula using the voltage and resistance values indicated above:

Vₒᵤₜ=R_{f}/Rᵢₙ(V₂−V₁) (1)

If the differential amplifier is operated only at a positive operating voltage, as is typically the case for a CMOS, then a voltage between operating voltage and digital ground is selected as analog ground V_{agnd}, typically the mean potential. If the two analog input voltages V₁ and V₂ only differ slightly, then output voltage Vₒᵤₜ will only exhibit a slight difference V_{diff} to the analog ground (positive or negative).

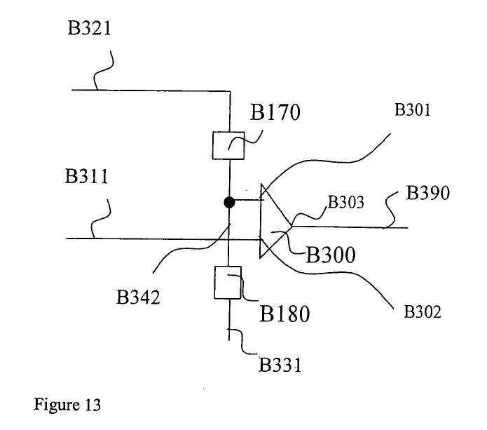

At this point, two comparators are used to check whether the output voltage is above V_{agnd}+V_{diff} (FIG. 12) or below V_{agnd}−V_{diff} with respect to the analog reference point (FIG. 13). In this context, in FIG. 12, input signal B221 is connected via resistor B150 having value R₁ to signal B242, which is connected to positive input B202 of operational amplifier B200. In addition, signal B242 is connected via resistor B160 having value R₂ to signal B231, which is used as a digital reference potential V_{dgng}. Negative input B201 of the operational amplifier is connected to input signal B211, which has the voltage value of a reference voltage V_{ref}. Output B203 of operational amplifier B200 is connected to output signal B290 which has voltage value V_{high}.

Correspondingly, in FIG. 13, input signal B321 is connected via resistor B170 having value R₃ to signal B342, which is connected to negative input B301 of operational amplifier B300. This signal B342 is also connected via resistor B180 having value R₄ to signal B331, which also has digital reference potential V_{dgnd}. Positive input B302 of operational amplifier B300 is connected to input signal B311 which has the voltage value of a reference voltage V_{ref}. Output B303 of operational amplifier B300 is connected to output signal B390 which has voltage value V_{low}.

This is accomplished by dimensioning values Rᵢ, R₂, R₃ and R₄ of resistors B150, B160, B170 and B180 in relation to fixed reference voltage V_{ref}, which is applied to signals B211 and B311, as follows:

V_{ref}=(V_{agnd}+V_{diff})*R₂/(R₁+R₂) (2)

V_{ref}=(V_{agnd}−V_{diff})*R₄/(R₃+R₄) (3)

V_{diff}=((V₂ₘₐₓ−V₁ₘᵢₙ)*R_{f}/Rᵢₙ)−V_{agnd} (4)

In this context, V₂ₘₐₓ denotes the maximally tolerated voltage value of V₂ at signal B121, and V₁ₘᵢₙ the minimally tolerated voltage value of V₁ at signal B111. The reference voltage source may be made available externally, or implemented by an internally realized bandgap (temperature-compensated and operating voltage-independent reference voltage). In equation (4), the maximally tolerated difference V_{diff} from the maximum positive deviation V₂ₘₐₓ and the corresponding maximum negative deviation V₁ₘᵢₙ is determined; i.e., (V₂ₘₐₓ−V₁ₘᵢₙ) is the maximally tolerated voltage deviation of redundant analog signals relative to one another, which are to be compared to one another.

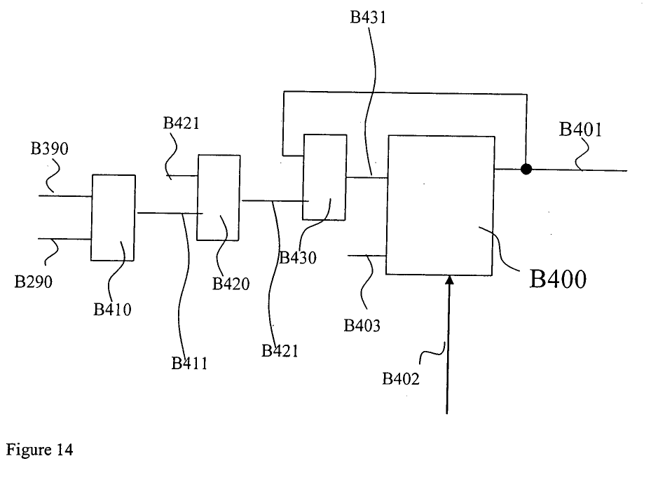

If one of the voltage values at the two signals B290 or B390 (V_{high} or V_{low}) is positive, then there is a greater deviation of the analog signals than should be tolerated. In the case that the processors which supply these analog signals are synchronized, then an error exists that must be stored and, if indicated, results in the output signals being switched off. Synchronous operation is given when, for example, the ready signal in the control register of the processing units in question is active, or when specific digital signals which signal a certain state of the analog signal in question and thus also the value to be compared in the sense of an identifier, are sent to the SCU. A circuit that stores the error is shown in FIG. 14. In this circuit, the two input signals B390 and B290 are linked via a NOR circuit B410 (logical OR circuit having subsequent inversion) to form output signal B411. This signal B411 is linked to input signal B421 in an additional NOR element B420 to form output signal B421. This signal B421 is linked in an OR circuit B430 with signal B401 to form signal B431, which is used as an input signal for memory element (D flip-flop) B400. By value 1, output signal B401 of this element B400 indicates an error. D-flip-flop B400 stores a 1, using clock pulse B403, if one of the two voltage values V_{low} or V_{high} is present at signals B390 or B290 in positive form, that is, as a digital signal, has the value high; signal B421 is not active and no reset signal B402 is present. The error remains stored until the signal reset has been active at least once. Care should be taken when dimensioning the circuits of FIGS. 11 through 13, that the resistances match one another, i.e., that the resistance ratios of R_{f} and Rᵢₙ, R₁ and R₂, as well as of R₃ and R₄ be constant, to the extent possible independently of manufacturing tolerances. Using signal B421, it is possible to control whether the circuit should be active, or whether the processing units are currently being synchronized, during which process no comparison should be made. Signal B402 resets a previous error and therefore permits a new comparison.

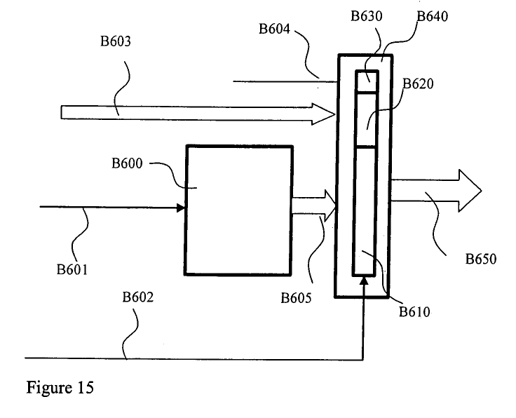

FIG. 15 shows an ADC. Depending on the existing requirements, for example with regard to conversion speed, accuracy, resolution, interference immunity, linearity and frequency spectrum, this ADC may be implemented using the various known conversion methods. Thus, for example, the principle of successive approximation may be selected, where the analog signal is compared to a generated signal from a digital-to-analog converter (DAC) using a comparator, the digital input bits of the DAC being systematically set to high on a trial basis from the MSB (most significant bit) to the LSB (least significant bit), and being reset again precisely when the analog output signal of the DAC has a higher value than the analog input signal (the signal to be converted). Using its digital bits from LSB to MSB, the DAC controls either resistors or capacitors by applying weightings 1, 2, 4, 8, 16, . . . in such a way that setting the next highest bit always has twice as great an effect on the analog value as the previous one. Once all bits have been set and possibly reset again on a trial basis, the value of the digital word corresponds to the digital representation of the analog input signal. For higher speed requirements, in the case of continuous data streams, a converter may also be used which continuously processes the analog signal and outputs a serial digital signal which approaches this analog data stream by the serial bit sequence. In this case, the digital word is represented by the bit sequence stored in a shift register. However, such converters are used on the assumption that continuous changes in the analog signal occur during the conversion period, because they are not able to process constant values. For lower speed requirements, converters which work in accordance with the counting principle may also be used which, for instance, use the input voltage or the input current to effect a corresponding constant charging or discharging of a capacitor connected to an integrator. The time required for this is measured and related by ratio to the time needed in the opposite sense for discharging or charging the same capacitor (integrator) using a reference voltage source or a corresponding reference current. The time unit is measured in clock pulses, and the number of clock pulses required is a measure of the analog input value. Such a method is, for instance, the dual slope method, where the one slope is determined by the discharging in accordance with the analog value, and the second slope is determined by the recharging in accordance with the reference value (see also http://www.exstrom.com/journal/adc/dsadc.html).

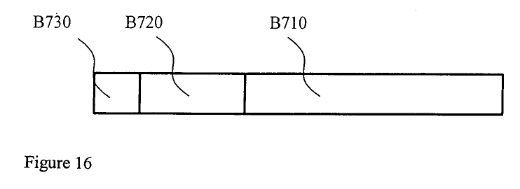

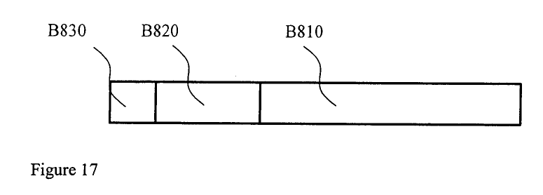

ADC B600 in FIG. 15 is controlled by a trigger signal B602, which is typically an output signal of the processor that supplies the analog signal and optionally an identifier B603 which provides information on the type of analog signal that is being supplied at the moment, to make possible a distinction among a plurality of analog signals. In response to trigger signal B602, the converted analog word in memory area B640 is accepted as a digital value in a register B610 and, optionally, together with identifier B603, which is stored in B620, and perhaps with an additional signal B604 (that is 1 for the identification of an analog value), which is stored in memory B630. Memory area B640 may advantageously be implemented as FIFO (first in, first out) as well, if a plurality of values are to be stored, and the value stored first is also to be output first again. If memory area B640 is used both for digital as well as for digitized analog values, all digital values are advantageously supplemented by one bit A=0 at the MSB location, correspondingly to B630, in order to distinguish them from digitized analog values where A=1 (B630) (see FIGS. 16 and 17). Both B602 and B603 are components of digital output data Oᵢ of a processor i. In FIG. 16, the parts of the stored digitized analog value are shown separately, as they are stored in the memory area. In this context, B710 is the digitized analog value itself; B720 is the associated identifier; and B730 is the analog bit which in this case is to be stored as 1. FIG. 17 shows a variant of a digital value stored in the same memory area. In B810, the digital value itself is stored; in B820, an identifier is stored optionally for this purpose, which, for instance, provides information on whether the digital word is to be compared at all or whether it may also include other conditions for the comparison. Value 0 is then stored in B830 in order to indicate that it concerns a digital value.

To compare the buffer-stored digital and analog signals, the storing sequence and, in some instances, the A bit (B730 or B830), as well as identifier B720 or B820 are checked in connection with converted digital value B710 or digital value B810. It is likewise possible for the analog and the digital signals to be accommodated in separate memories (two FIFOs), for example, due to the difference in bit width. The comparison then takes place in an event-controlled manner; whenever a value of a processor is transmitted to the SCU, it is checked whether the other participating processors have already provided such a value. If this is not the case, the value is stored in the corresponding FIFO or memory; otherwise, the comparison process is carried out directly, it being possible for the FIFO to be used as a memory here as well. A comparison process is always completed, for example, when the participating FIFOs are not empty. If there are more than two participating processors or comparison signals, a voting process may be used to ascertain whether all signals are permitted for the distribution process (fail silent behavior) or whether perhaps the error state is signaled only by an error signal.

1-16. (canceled)

17. A method for performing a switch-over operation and a data comparison operation in a computer system having at least three processing units, comprising:
performing a switch-over operation between at least two operating modes of the computer system by a switch-over unit, wherein a first operating mode is a comparison mode and a second operating mode is a performance mode, wherein a data comparison is performed in the comparison mode by a comparison unit; and
performing a voting process in the comparison mode, wherein the voting process includes a two-out-of-three weighting, and wherein a control unit is provided to set the voting.

18. The method as recited in claim 17, wherein the control unit includes a storage unit, and wherein an identifier for setting the voting is stored in the storage unit.

19. The method as recited in claim 18, further comprising:
performing an error detection based on a result of the voting process; and
storing a corresponding error status.

20. The method as recited in claim 19, wherein the error statistic is stored in the storage unit.

21. The method as recited in claim 20, wherein the identifier is written into the storage unit by a processing unit, and the error status is written into the storage unit by at least one of the comparison unit and the switch-over unit.

22. The method as recited in claim 17, wherein data are buffered prior to being input into the comparison unit.

23. The method as recited in claim 18, wherein a processing unit of the computer system specifies the identifier used for setting the voting.

24. The method as recited in claim 18, wherein the identifier used for setting the voting is specified by a source external to the computer system.

25. The method as recited in claim 18, wherein a plurality of sources is provided for specifying the identifier used for setting the voting, and wherein all the sources provided for specifying the identifier are linked in such a way that the setting of the voting is achieved by an OR operation.

26. A device for performing a switch-over operation and a data comparison operation in a computer system having at least three processing units, comprising:
a switch-over unit configured to perform a switch-over operation between at least two operating modes, wherein a first operating mode is a comparison mode and a second operating mode is a performance mode;
a comparison unit configured to perform a comparison, wherein provision is made in the comparison mode for a voting process, wherein the voting process includes a two-out-of-three weighting; and
at least one source for setting the voting, wherein the at least one source is a control unit.

27. The device as recited in claim 26, wherein the control unit includes a storage unit, and wherein an identifier for setting the voting is stored in the storage unit.

28. The device as recited in claim 27, wherein the storage unit is a control register.

29. The device as recited in claim 26, further comprising:
at least one input buffer memory, wherein the data are buffered prior to being input into the comparison unit.

30. The device as recited in claim 26, wherein the control unit for setting the voting is a source external to the computer system.

31. The device as recited in claim 26, wherein the control unit for setting the voting is a source internal to the computer system.

32. The device as recited in claim 26, wherein a plurality of sources is provided for setting the voting, and wherein all the sources for setting the voting are linked in such a way that the setting of the voting is achieved by an OR operation.
